(19) United States
(12) Patent Application Publication
(10) Pub. No.: US 2017/0305109 A1
(43) Pub. Date: Oct. 26, 2017

(54) SYNTHETIC-TEXTILE HYBRID FABRIC AND MEANS AND METHOD FOR MANUFACTURING SAME

(71) Applicant: Elinor ROSENTAL, Netanya (IL)

(72) Inventor: Elinor Nathaniel, Netanya (IL)

(21) Appl. No.: 15/511,790

(22) PCT Filed: Sep. 16, 2015
(86) PCT No.: PCT/IL2015/050941

§ 371 Date: Mar. 16, 2017

Related U.S. Application Data
(60) Provisional application No. 62/050,778, filed on Sep. 16, 2014.

(51) Int. Cl. B32B 5/24; B32B 7/12; B32B 5/02; B32B 27/08; B32B 27/12; B32B 5/22; B32B 27/06

(52) U.S. Cl. CPC B32B 5/245; B32B 5/22; B32B 7/12; B32B 27/065; B32B 27/08; B32B 27/12; B32B 5/024; B32B 2307/51; B32B 2307/412; B32B 2307/41; B32B 2307/402; B32B 2307/3065; B32B 2307/558; B32B 2307/712; B32B 2307/72; B32B 2307/75; B32B 2479/00; B32B 2607/02; B32B 2571/02

(57) ABSTRACT

A hybrid fabric made of at least one textile base layer and at least one synthetic layer, where the synthetic layer is at least partially embedded within the textile base layer. The embedded synthetic layer imparts numerous qualities to the hybrid fabric formed and possible designs visible through the surface of the fabric. The hybrid fabric may be manufactured in different methods including hot and cold press, knitting, felting and use of intermediate linking adhesive or polymeric layer.

### TECHNICAL FIELD

The present invention pertains to hybrid fabrics. More particularly, the present invention pertains to hybrid fabrics with textile base layer and embedded polymeric layer and means and methods for manufacturing such fabric.

### BACKGROUND

Current methods of manufacturing hybrid fabrics with natural and synthetic materials include interwoven threads made of natural and synthetic materials. Such semi-synthetic, semi-natural fabrics impart advantages to garments made of them such as elasticity combined with natural feel. Another method of manufacturing hybrid fabrics uses lamination to partially or completely cover natural textiles with synthetic materials for different purposes such as protection from abrasion and tearing, repelling water and other fluids, and extending fabric life. Lamination of synthetic materials on natural textiles is well-known in the art. See, for example, GB 971 434, GB 1 214 281, GB 1 276 412, US 2003/0192109 and U.S. Pat. No. 4,874,655. Lamination uses different techniques as fusion, vacuum, pressing and hot press to adhere a layer of synthetic polymer to the surface of natural textile without using intermediate adhesive. The objective in lamination is to essentially cover the textile, possibly by linking the laminate to the top surface of the textile, without allowing the synthetic layer to penetrate the textile. The disadvantage in such side effect is particularly pointed out and addressed in U.S. Pat. No. 4,784,655, where chemical modification of the thermoplastic used to cover selected parts of a garment takes place in situ, thus absolving the requirement of using a different linking material. Such external cover masks the natural feel of the textile.

The present invention, however, is directed to embedding polymeric layer within a textile cloth and not only fusing it to the surface.

It is, therefore, an object of the present invention to provide hybrid fabric that comprises textile base layer with synthetic layer embedded in it.

It is yet another object of the present invention is to provide means for manufacturing such hybrid fabric of textile base layer with synthetic layer embedded in it.

Yet another object of the present invention is to provide a method for manufacturing a hybrid fabric by embedding synthetic layer in a textile base layer.

### SUMMARY

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

In one aspect, the present invention provides textile-synthetic hybrid fabric, in which a synthetic layer is at least partially embedded within a textile base layer. In one particular embodiment, the synthetic layer provides the protection necessary for the textile base layer, yet retains the look and feel of the textile base layer at its surface. Further, such actual hybrid fabric may be provided in a variety of textured, colored, patterned and designed surfaces depending on the texture, color, pattern and design of the embedded synthetic layer. In still another particular embodiment, the intentional partial embedding of the synthetic layer within the textile base layer reinforces the attachment of a cover formed by that part of the synthetic layer that covers the outer surface of the textile base layer.

Therefore, in another embodiment, a synthetic layer embedded in a textile base layer to form textile-synthetic hybrid fabric, imparts textured or smooth surface to the fabric, where the textured surface may be felt or visible through the textile base layer.

In still another embodiment, the synthetic layer is colored with a color imparted to the textile base layer or the synthetic layer is transparent and/or colorless, where, when colored, the synthetic layer blends with or takes over the color of the textile base layer. When opaque, the synthetic layer affects the look of the textile base layer and covers it. When the synthetic layer is both colored and transparent, it may impart a colored shade to the textile base layer.

In still another embodiment, the synthetic layer has a particular pattern that is retained after embedding within the textile base layer and visible through the surface of the textile base layer. Otherwise, the pattern of the synthetic layer may be colorless and partly visible or not visible at all through the surface of the textile base layer.

In still another embodiment, the texture of the synthetic layer protrudes out of the surface of the textile base layer partially or completely. When the texture of the synthetic layer is completely embedded within the textile base layer, it may turn to a pattern which is visible through the surface of the textile base layer. This way the texture of the synthetic layer merges with the surface of the textile base layer and alters the textures and/or patterns of the original synthetic and textile base layers. This may happen with textured synthetic layers. Smooth synthetic layers are not likely to show the same effect.

The combination of textile base layer and synthetic layer in the present invention produces a hybrid fabric with qualities, which are a merger, mix or combination of the original qualities of the layers. Accordingly, the hybrid fabric may be designed to obtain different qualities depending on the qualities of the original textile base and synthetic layers.

The textiles and synthetic materials that may be co-operated in the hybrid fabric of the present invention are not limited to certain types or qualities. In fact, any type of textile material may be used for the textile base layer. Similarly, any type of synthetic material may be used for embedding a synthetic layer in the textile base layer. Accordingly, the inherent and acquired properties of the synthetic layer may be imparted to the textile base layer, while retaining the properties of the textile base layer and modifying or retaining its look and feel. Synthetic layer embedded in a textile base layer is advantageous over lamination with synthetic layer and cost effective relative to interwoven synthetic and natural threads, since it is more strongly secured within the textile base layer, yet capable of providing its inherent and acquired properties to the textile, e.g., protection from abrasion and tearing, repelling fluids, flexibility, elasticity, color, shading and texture.

Other properties of the synthetic layer that may be available to the hybrid fabric of the present invention are as follows:

Pleats and creases heat-set at higher temperatures

Improved weathering properties

Sunlight resistance

Softer “Hand”

Elevated melting point

Superior colorfastness

Excellent abrasion resistance

Easy dye

Higher impact resistance

More rapid moisture absorption, greater elasticity and elastic recovery

Variation of luster, between, for example very lustrous, semilustrous and dull

Durability: high tenacity of fibers, particularly useful for seatbelts, tire cords, ballistic cloth and other uses

High elongation

High resilience

High resistance to insects, fungi, animals, as well as molds, mildew, rot and many chemicals

Flame resistance: melting instead of burning

Good specific strength

Transparency to infrared light

Particular non-limiting examples of synthetic materials that may be used for embedding synthetic layer in a textile base layer are listed as follows: Olefin polymers, particularly PE (Polyethylene) and PP (Polypropylene), HDPE (High Density PE), MDPE (Medium-density polyethylene), LLDPE (Linear Low Density PE),and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PCL (Polycaprolactone), PEA (Polyethylene adipate), PBS (Polybutylene adipate), PET (Polyethyleneterphthalate), PBT (Polybutyleneterphthalate), PEN (Polyethylene naphtalane), Styrene polymers, particularly PS (Polystyrene), Styrene-Butadiene polymers, PUR (Polyurethane), foamed PUR, Fluorinated polymers, particularly Teflon, Nylon 6,6, and Nylon 6 and combination thereof.

Still in another particular embodiment, the synthetic layer may further comprise additives of different types such as plasticizers, softeners, UV absorbers, static charge neutralizing fillers and flame retardants, thereby imparting the properties of these additives to the hybrid fabric.

In still another particular embodiment, the synthetic layer may be of any desirable thickness before embedding it in the textile base layer. Accordingly, the thickness will affect the total thickness of the hybrid fabric and the conditions required for manufacturing it. In one particular non-limiting example, the thickness of the synthetic layer may vary between 50 μm and 6 centimeters.

The textile base layer in the present invention may be obtained by any of the techniques of producing fabrics. Such techniques may be weaving, knitting, spreading, crocheting, felting and bonding. The textile base layer may then be woven, knitted, felted, braided, laced, interlaced or bonded. Particular non-limiting examples of materials that may be used for the textile base layer are listed as follows: wool, cashmere, silk, satin, velvet, taffetas, cotton, flax, jute, hemp, modal, bamboo fiber, seaweed, alginate, lyocell (manmade fabric derived from wood pulp), Cordura (nylon, nylon mixed with cotton or other natural fibers), basalt fibers (used for vinyl tiles, sheeting, curtains and fire blankets), metal fibers, synthetic fibers such as aramid, acrylic, nylon, spandex (i.e. lycra), olefin fibers, inego (polylactide fibers), lurex (metallic fibers), milk protein-based fibers, carbon fibers and mixtures of synthetic and natural fibers and any combination thereof. Such combination may comprise parts of textile base layer unified into a single textile base layer with a synthetic layer embedded within also serving as adhesive that connects the parts together.

In one particular embodiment, the surface density and the number of threads in a defined surface of the textile base layer may vary.

When coloring is desired, appropriate colorants, pigments or dyes, natural or synthetic may be introduced into the synthetic textile. Particular non-limiting examples of types of colorants, pigments and dyes that may be used in the present invention are azo dyes, anthraquinone dyes and phthalocyanines. Another classification of colorants may be used to distinguish between different families as follows: Dyes with varying water solubility including acid dyes, basic dyes, metal-complex dyes, direct dyes, disperse dyes; reactive dyes, vat dyes, sulfur dyes; Pigments, organic or synthetic, from azo and phthalocyanines families, which are usually employed in the plastic industry. The colorants may be provided as solid powders, liquids or powders soluble in water or any other liquid.

In one particular embodiment, the synthetic material for the synthetic layer may be recycled, and comprise a mixture of different types of synthetic polymers. Otherwise, it may contain single type of synthetic polymer, a mixture of synthetic polymers with known relative amounts or block co-polymers that comprise different polymeric compounds chemically bonded to each other and forming a single polymer chain.

The method of manufacturing the textile-synthetic hybrid fabric of the present invention is generally outlined in the following:
Laying the synthetic layer onto a textile base layer; and
Embedding the synthetic layer at least partly within the textile base layer.

In one particular embodiment, the method further comprises a preliminary step of:

Cleaning and drying the synthetic and textile base layer.

In still another particular embodiment, the method further comprises:

Coloring the synthetic layer, or using a pre-colored synthetic layer; and

Removing residues of dye left on the hybrid fabric.

In one particular embodiment, the method further comprises a preliminary step of:

Cooling the synthetic fabric formed.

In one particular embodiment, removing is made by washing.

The application of this general method may be with any one of the following ways: Dying—Dying may be done in any of various ways.

1. One possible way is dying the synthetic layer before embedding it in the textile base layer, letting the colorant dry, then embedding the synthetic layer within the textile base layer.

2. Second possible way is dying the synthetic layer before embedding, then embedding and letting the colorant dry during embedding.

3. Third possible way is dying the synthetic layer after embedding it within the textile base layer.

Any of the ways of dying may be implemented together with any of the methods of embedding the synthetic layer. In particular, when using hot press and liquid dyes, the heat is exploited to let the pigment solvent evaporate, at least mostly, and not enclose within the hybrid fabric formed.

Dying the synthetic layer may be done either manually or mechanically as part of the manufacturing process of the present invention, or the synthetic layer is already provided with pigments within. The same applies to the textile base layer, where its coloring is done by embedding the dyed synthetic layer within it. To this end, solid pigments or liquid dyes may be used to color the synthetic layer.

In one particular embodiment, dying of the synthetic layer is accompanied by printing with any known printing technology on synthetic materials. Printing may be of any type of pattern or picture on the surface of the synthetic layer. Thus, the surface of the hybrid fabric may be decorated with the pattern or design printed on the surface of the embedded synthetic layer.

Embedding—Embedding techniques and means for embedding the synthetic layer in the textile base layer may be done in any one of the following ways:

1. Hot press—The synthetic layer is placed above or below the textile base layer, preferably with protective covers on the outer surfaces of the synthetic and textile base layer. The press is heated to selected temperature and the press plates apply force sufficient to let the synthetic layer penetrate the textile base layer. Pressure is applied for a selected period of time. Then the plates are lifted off of the hybrid fabric formed, the fabric is let to cool and the protective covers are peeled off of the outer surfaces of the fabric.

2. Cold press—The same as with hot press without elevation of temperature.

3. Adhesive—Adhesive may be used to attach the synthetic layer to the top or bottom surface of the textile base layer. Then hot press or cold press may be used to let the synthetic layer penetrate the textile base layer.

4. Porous or grid form textile—Porous or grid form of the textile base layer may be used to lock the synthetic layer within. Any of the techniques detailed above, namely hot or cold press or incorporation of adhesive may be used to embed the synthetic layer within the porous or grid form textile base layer.

5. Felting—Felting may be used to interweave the synthetic layer within the textile fibers that form the textile base layer and obtain the hybrid fabric. Accordingly, synthetic fibrous layer is superimposed on a felt base layer. The layers are agitated together in warm soapy water and the fibers allowed adhering to each other. Alternatively, the felt base layer and the synthetic fibrous layer are interwoven with each other with needles to obtain the hybrid fabric.

6. Sewing—Fibrous textile base and synthetic layers are sewn together to form the hybrid fabric.

In any one of the techniques of embedding the textile base layer may be pre-treated by increasing its vacant space between its fibers to allow the synthetic layer better embed within.

Use of low density material for the synthetic layer may be particularly efficient for high density textile base layer. In such combination, the low density synthetic material is more easily embedded within the textile base layer. Still in another particular embodiment, the synthetic layer is provided with holes or gaps in it also to enable easier embedding within the textile base layer.

In hot or cold press, the protective cover that separates between the press plates and the layers may be, for example, heat-durable paper for obtaining a more opaque look to the surface of the hybrid fabric or Teflon sheet for brighter or shinier look. Such protective paper or Teflon sheet may cover the pressed fabric on both sides.

In one particular embodiment, the method of manufacturing the hybrid fabric may further comprise forming a thermoplastic sleeve that covers the hybrid fabric. This may be obtained in any of the following methods:

1. Pre-covering—Laminating the two layers put together with thermoplastic layer that will be melted on the hybrid fabric formed or adhered to it.

2. Post-covering the hybrid fabric with thermoplastic layer, for example, with appropriate adhesive.

In still another particular embodiment, the thermoplastic sleeve is shrink-fit.

In still another particular embodiment, the method of manufacturing the hybrid fabric further comprises a preliminary step of assuring that the synthetic and textile base layers are wrinkle free.

In one particular embodiment, the textile base layer is bright colored for emphasizing textures.

In still another particular embodiment, the adhesive may be replaced with intermediate synthetic layer that interlinks with the synthetic layer on one side and textile base layer on the other side. One particular example of such intermediate synthetic layer is EVA (Ethylene vinyl acetate) polymer. In still another particular embodiment, such intermediate layer secures the embedded synthetic layer within the textile base layer, preventing its peeling off of the hybrid fabric.

In still another particular embodiment, the textile base layer is provided with textured surface that remains after embedding the synthetic layer within. Otherwise the textile base layer is without texture. In still another particular embodiment, the textile base layer turns rigid upon embedding the synthetic layer within it when forming the hybrid fabric.

When transparent textile base layer is used, a more uniform look of the hybrid fabric is obtained upon embedding a transparent synthetic layer in it.

Embedding a synthetic layer within may be done on both sides of a textile base layer. Therefore, a sandwich of synthetic-textile base-synthetic layer configuration may be used to obtain a double embedded hybrid fabric. As a result different synthetic layers may be used on both sides, providing different, transparency, texture, color, look and feel and other features to the two sides of the hybrid fabric.

The hybrid fabric obtained in any one of the alternatives detailed above may be easily sewn and washable.

In one particular embodiment, a filling may be placed within the hybrid fabric, providing it volume and other qualities such as cushioning, shock absorption and the like.

The hybrid fabric obtained has pleasant feel unlike fabrics covered with protective synthetic layers, with at least one of the following qualities added thickness due to the embedded synthetic layer, increased strength, durability, toughness or flexibility and elasticity depending on the characteristics of the embedded synthetic layer and its combination and synergy with those of the textile base layer.

In one particular embodiment, the texture of the hybrid fabric is obtained in its manufacture, for example with patterns placed on the plates in hot or cold press.

The manufacturing process is relatively easy and fast and does not require complicated preparations, machinery or materials.

In one particular embodiment, the press used in hot or cold press is drum press with drums rolling parallel each other forming a gap between them for transporting the layers to be pressed to a hybrid fabric. The drums provide smaller interface with the layers and shorten the time of point exposure to heat of every stripe of the layer passing between the drums, when hot press is involved. On the other hand, increased pressure and slower speed of rolling are applied. Such means and method may provide improved hybrid fabric relative to plate press.

Several parameters are involved when hot press, e.g., plate press, drum press, is used to manufacture the hybrid fabric.

Temperature of use may be set to any value between 80° C. and 300° C.

Pressure may be set at any level between 3,000 to 300,000 psi.

Time of hot pressing may be set between 1 to 5 minutes.

In any case, interplay between these three parameters is possible. Thus, the time may be shortened when higher pressure and temperature are used. Higher pressure and time may be applied when lower temperature is used and so on. In particular, the values of these parameters may be determined according to the particular materials of synthetic layer and textile-base layer used to produce the hybrid fabric and/or the desirable result of hybrid fabric with synthetic layer fully or partially embedded within the textile base layer and respective composite, fully covered or fully exposed surface of the textile base layer. Another consideration is the efficacy of the process of manufacturing the hybrid fabric, cost effectiveness, product quality and its required characteristics.

The same considerations apply also to other techniques and technologies for manufacturing the hybrid product of the present invention. Accordingly, values of process parameters are set to obtain the desirable characteristics and quality of the hybrid fabric. In cold or hot press, for example, the higher pressure may be applied together with proper intermediate adhesive or EVA polymer to at least partly embed the synthetic layer within the textile base layer. Similarly, longer time will be required to obtain the hybrid fabric.

In still another particular embodiment, multi-layer hybrid fabric may be manufactured in the method of the present invention. For example, different types of textile base layers may be combined with each other with embedded synthetic layers placed between them and hot or cold pressed together, adhered with appropriate adhesive, felted or sewn. Further, interlining, such as foamed synthetic sheet, hollow fibers filling or sponge may be enclosed between the textile base layers and retained upon embedding the synthetic layers within the textile layers. Likewise, a number of synthetic layers may be put together to form multi-layer hybrid fabric with several synthetic layers embedded in the textile base layer(s).

### EXAMPLES

The following describes particular non-limiting examples of hybrid fabrics and methods of manufacturing them.

Synthetic sheet made of polyethylene, recyclable plastic sheet, or foamed polyethylene sheet with thickness of between 2 and 5 millimeters is placed on a textile base layer. In one particular example, the polyethylene foamed sheet thickness was of 2 millimeters thickness.

The layers were placed one above the other on a plate press and covered with Teflon coating on single or both sides to avoid adhering of the synthetic layer(s) to the plates. The temperature of the press was elevated to 180° C. and the plates were pressed on the layers for about 2 minutes, then lifted and the hybrid fabric form removed and allowed to cool at room temperature. In another example, the hybrid fabric formed was immediately put in ice-bath for quenching.

In another example, the Teflon cover was replaced with heat-durable paper, such as paper used for baking ovens. This was a cost effective solution, but also produced a more opaque appearance to the hybrid fabric, where use of the Teflon cover produced a shinier look.

One of the advantages over current methods is the texture transformation achieved in the new material. This texture improvement, compared to either of the base components (synthetic or textile) on their own, or to other heat pressed fabric hybrids. From surveys and tests that the inventor performed, the newly achieved texture is significantly more desirable compared to other fabrics.

Another main advantage are the new colors that can be achieved in the produced new material via the method. The colors are never exactly repeated and the different textures of the synthetic layers enable new and different color patterns every time.

Upon painting and embedding with hot press, the hybrid fabric results in varying sub-tones throughout the surface of the fabric and no area is like another. The sub-tones created distinguish the new hybrid fabric produced. This is particularly relevant when dyes and/or a textured synthetic layer are used.

In one example, synthetic layers with water repellent or water resistant qualities were used over textile base layers made of materials, vulnerable when in contact with water. The synthetic and textile base layers were hot pressed in plate press and the hybrid fabric obtained proved to impart the water repellant or water resistant qualities to the textile layer, yet kept the original feel of the textile.

It should be noted that from a point of view of process efficiency, a bigger plate press or drum press enable faster production yet produces equally good hybrid fabric.

In the examples described above and other example, the usual temperature in the heat press ranged between 80° C. and 300° C. In preferable application, the temperature used was 180° C.

The time it takes to correctly join the layers by heat press is between 1.5 and 5 minutes. Preferably 2 minutes are required in heat press. The method process is thus time saving, compared to current production methods.

The hybrid fabric produced is essentially a new material by itself, which separates it from either of the two basic components from which it was made, and forms a new interpretation of fabric and a new raw material.

Regarding coloring, dyes or pigments are placed between the synthetic and textile base layers and “locked” there. The result is improved, enhanced or emphasized texture and color of the hybrid fabric. When dyes are used in situ, namely in the manufacturing process, the liquid that carries the pigments is volatile and evaporates upon heat pressing.

The embedded synthetic layer also enables the hybrid fabric to be washable, by hand, or in a washing machine. Superfluous dye may be washed off after several washings.

In the examples manufactured of the hybrid fabric, the new material can be sewn onto other fabrics, or to itself.

Once the heat press process is done, the partially molten synthetic layer becomes an integral part of the textile, and achieves special/new colors and textures.

In other examples, polyethylene sheets purchased, manufactured or recycled were used to manufacture the hybrid fabric. The reclaimed polyethylene abundantly used in packaging and protective covers indirectly helps in keeping clean environment and reducing production of new polyethylene batches. This is particularly helpful since polyethylene as well as many other polymeric materials (see the list of polymers above) is not biodegradable, and for which there are no effective recycling processes. Accordingly, such polymers turn into waste with high collateral damage, including storing, melting and re-manufacturing.

In another example of the method of manufacturing a hybrid fabric the following steps were carried out:

A. A white opaque synthetic sheet was manually colored with liquid colors (pigment or any other concentrated color combined with water which gives the special appearance after melting).

B. The colored synthetic layer was let to dry at room temperature. Alternatively, the colored synthetic layer was placed over a textile base layer.

C. The two layers were covered with Teflon cover or heat-durable paper and placed in plate hot press.

D. The press was heated and the plates were applied on the covered layers under pressure at a temperature of 180° C. and remained like this for 2 minutes.

E. Then the plates were lifted and the hybrid fabric was taken out, the cover was removed and the hybrid fabric was let to cool at room temperature.

The result was hybrid fabric colored by the synthetic layer with the feel of the original textile base layer.

The hybrid fabric is used as the basis for creating a wide range of products with a variety of colors. A custom fabric is determined to some extent by the consumer in order to have some control over the design.

The new hybrid fabric produced can expand the scope and purpose of materials in these products, and can be used for the garment industry, footwear, wallpaper, cushions and garden furniture (pergola, sofas), and even jewelry. Production of such items with hybrid fabric of the present invention can be used manually as well as in industrially.

In one example test, in which a wearable jeans was made from the new hybrid fabric, the color was retained in its close-to-original condition even after 10 washes.

In terms of heavy-type process, all types of textiles (natural and synthetic) were successfully used to produce the hybrid fabric of the present invention. In one example, interwoven fabric (which is less flexible) is found to be stronger than other fabrics and thus better for the method. For example, fabrics with looped weaving will be less desired for this method for their flexibility and tendency for distortion once under the heat-press.

In one example, synthetic layer made of low density polymeric material was found preferable for manufacturing hybrid fabric in hot press.

The following recyclable synthetic materials for were tested with similar results in terms of hybrid fabric density and qualities: foams, polyethylene bubble sheets, polyethylene bags, labels of bottled drinking water, boxes of different toilet paper, sixpacks of bottled drinking water, etc.

In another example, the confined liquid paints in nylon synthetic layer were obtained with different coloring methods. The results were not quite repeatable and only partly controllable.

In another example, the final hybrid fabric formed was laminated as follows: The hybrid fabric was dressed with shrink sleeves were and then put back in the hot press for 2 minutes. The laminated hybrid fabric gave stronger and water-tight with 100% water repellant fabric and not just the outside of the sheet.

In still another example, synthetic layer of bubble wrap was colored, placed over a textile base layer and covered with protective cover and hot pressed for 2 minutes. The hybrid fabric was taken out of the press plates, the cover removed and the hybrid fabric let to cool at room temperature. The bubble wrap was embedded in the textile base layer, and its bubble pattern was visible through the surface of the hybrid fabric.

Those skilled in the art to which this invention pertains will readily appreciate that numerous changes, variations and modifications can be made without departing from the scope of the invention mutatis mutandis.

1. A hybrid fabric comprising:
at least one textile base layer; and
at least one synthetic layer,
wherein said synthetic layer is at least partially embedded within said textile base layer.

2. The hybrid fabric according to claim 1, wherein said textile base layer is obtained by weaving, knitting, spreading, crocheting, felting and bonding.

3. The hybrid fabric according to claim 2, wherein said textile base layer is made of materials selected from : wool, cashmere, silk, satin, velvet, taffetas, cotton, flax, jute, hemp, modal, bamboo fiber, seaweed, alginate, lyocell (manmade fabric derived from wood pulp), Cordura (nylon, nylon mixed with cotton or other natural fibers), basalt fibers (used for vinyl tiles, sheeting, curtains and fire blankets), metal fibers, synthetic fibers such as aramid, acrylic, nylon, spandex (i.e. lycra), olefin fibers, inego (polylactide fibers), lurex (metallic fibers), milk protein-based fibers, carbon fibers and mixtures of synthetic and natural fibers and any combination thereof.

4. The hybrid fabric according to claim 3, wherein said combination comprise parts of said materials of said textile base layer, said part unified into a single textile base layer with said synthetic layer embedded within.

5. The hybrid fabric according to claim 1, wherein said synthetic layer is made of synthetic polymeric materials selected from Olefin polymers, particularly PE (Polyethylene) and PP (Polypropylene), HDPE (High Density PE), MDPE (Medium-density polyethylene), LLDPE (Linear Low Density PE),and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PCL (Polycaprolactone), PEA (Polyethylene adipate), PBS (Polybutylene adipate), PET (Polyethyleneterphthalate), PBT (Polybutyleneterphthalate), PEN (Polyethylene naphtalane), Styrene polymers, particularly PS (Polystyrene), Styrene-Butadiene polymers, PUR (Polyurethane), foamed PUR, Fluorinated polymers, particularly Teflon, Nylon 6,6, and Nylon 6 and combination thereof.

6. The hybrid fabric according to claim 5, wherein said synthetic polymeric materials further comprise additives.

7. The hybrid fabric according to claim 6, wherein said additives are selected from plasticizers, softeners and flame retardants.

8. The hybrid fabric according to claim 1, wherein said synthetic layer is colored with a color imparted to said textile base layer, wherein said color is transparent or opaque.

9. The hybrid fabric according to claim 8, wherein said color is provided by colorants, pigments or dyes selected from azo dyes, anthraquinone dyes and phthalocyanines. Another classification of colorants may be used to distinguish between different families as follows: Dyes with varying water solubility including acid dyes, basic dyes, metal-complex dyes, direct dyes, disperse dyes; reactive dyes, vat dyes, sulfur dyes; Pigments, organic or synthetic, from azo and phthalocyanines families, which are usually employed in the plastic industry. The colorants may be provided as solid powders, liquids or powders soluble in water or any other liquid.

10. The hybrid fabric according to claim 1, wherein said synthetic layer is transparent and/or colorless.

11. The hybrid fabric according to claim 8, wherein surface of said synthetic layer further comprises a printed pattern or picture, said printed pattern or picture is visible through surface of said hybrid fabric.

12. The hybrid fabric according to claim 1, wherein said synthetic layer imparts said textile base layer with any one, part or all of protection from abrasion and tearing, repelling fluids, flexibility, elasticity, color, shading and texture.

13. The hybrid fabric according to claim 12, wherein said synthetic layer further imparting said textile base layer with any one, part or all of pleats and creases heat-set at higher temperatures, improved weathering properties, sunlight resistance, Softer “Hand”, elevated melting point, superior colorfastness, excellent abrasion resistance, easy dye, higher impact resistance, more rapid moisture absorption, greater elasticity and elastic recovery, variation of luster, between, for example very lustrous, semilustrous and dull, durability: high tenacity of fibers, particularly useful for seatbelts, tire cords, ballistic cloth and other uses, high elongation, high resilience, high resistance to insects, fungi, animals, as well as molds, mildew, rot and many chemicals, flame resistance: melting instead of burning, good specific strength, and transparency to infrared light.

14. The hybrid fabric according to claim 1, wherein thickness of said synthetic layer is between 50 μm and 6 centimeters.

15. The hybrid fabric according to claim 1, further comprising thermoplastic shrink fit sleeve covering said hybrid fabric.

16. The hybrid fabric according to claim 1, further comprising adhesive configured for adhering said synthetic layer to said textile base layer.

17. The hybrid fabric according to claim 1, further comprising intermediate synthetic layer configured for interlinking with said synthetic layer on one side and said textile base layer on the other side.

18. The hybrid fabric according to claim 17, wherein said intermediate synthetic layer is EVA (Ethylene vinyl alcohol) polymer.

19. The hybrid fabric according to claim 1, wherein outer surface of said hybrid fabric is surface of said textile base layer or textured mixture of said surface of said textile base layer and surface of said synthetic layer.

20. The hybrid fabric according to claim 19, wherein texture of said synthetic layer protrudes out of said surface of said textile base layer.

21. The hybrid fabric according to claim 19, wherein texture of said synthetic layer is embedded within said surface of said textile base layer.

22. The hybrid fabric of claim 1, wherein said synthetic layer is partly embedded within said textile base layer and covers outer surface of said textile base layer.

23. The hybrid fabric according to claim 1, comprising two of said synthetic layers, wherein each of said synthetic layers is embedded within said textile base layer on one surface of said textile base layer.

24. The hybrid fabric according to claim 1, comprising at least two textile base layers connected to each other with said synthetic layer.

25. The hybrid fabric according to claim 1, comprising a plurality of synthetic layers embedded in said at least one textile base layer.

26. The hybrid fabric according to claim 24 or 25, further comprising a filling placed within said hybrid fabric, said filling providing said hybrid fabric any one, part or all of volume, cushioning and shock absorption.

27. The hybrid fabric according to claim 1, wherein said synthetic layer comprises a pattern, wherein said pattern is visible through surface of said textile base layer.

28. The hybrid fabric according to claim 1, wherein said synthetic layer is made of low density material enabling efficient embedding within high density textile base layer.

29. The hybrid fabric according to claim 1, wherein said synthetic layer comprises holes or gaps in it, said holes or gaps enabling easier embedding within said textile base layer.

30. The hybrid fabric according to claim 1, wherein said synthetic layer is selected from recyclable foams, polyethylene bubble sheets, polyethylene bags, labels of bottled drinking water, boxes of different toilet paper, sixpacks of bottled drinking water, etc.

31. The hybrid fabric according to claim 1, suitable for manufacturing garment industry, footwear, wallpaper, cushions and garden furniture (pergola, sofas), and even jewelry.

32. A method for manufacturing hybrid fabric comprising:
laying said synthetic layer onto a textile base layer; and
embedding said synthetic layer in said textile base layer to form said hybrid fabric.

33. The method according to claim 32, further comprising:
cleaning and drying said synthetic layer and textile base layer.

34. The method according to claim 32, further comprising:
dying said synthetic layer, or using a pre-colored synthetic layer;
removing residues of dye left on the hybrid fabric.

35. The method according to claim 32, further comprising:
cooling the synthetic fabric formed.

36. The method according to claim 34, wherein said dying comprises one of:
i. dying and drying said synthetic layer before embedding it in the textile base layer.
ii. dying said synthetic layer before embedding and drying during embedding; and
iii. dying said synthetic layer after embedding within said textile base layer.

37. The method according to claim 32, wherein said method is done with any one of hot press, cold press, felting and sewing.

38. The method according to claim 37, wherein said hot or cold press further comprising adhering said synthetic layer to said textile base layer with adhesive.

39. The method according to claim 37, wherein said hot or cold press further comprising interlinking said synthetic layer and textile base layer with EVA polymer.

40. The method according to claim 37, wherein said textile base layer is porous grid configured to lock said synthetic layer.

41. The method according to claim 37, wherein said hot or cold press further comprising covering said synthetic layer overlaid on said textile base layer with protective cover.

42. The method according to claim 41, wherein said protective cover is heat-durable paper or Teflon sheet.

43. The method according to claim 37, wherein temperature of heating in said method of hot press is between 80° C. and 300° C.

44. The method according to claim 43, wherein said temperature is 180° C.

45. The method according to claim 37, wherein pressure applied in said hot or cold press is between 3,000 psi and 300,000 psi.

46. The method according to claim 37, wherein time of retaining said synthetic layer and textile base layer in said hot or cold press is between 1 and 5 minutes.

47. The method according to claim 37, wherein temperature, pressure and time parameter values of said method are determined according to particular materials of said synthetic layer and textile-base layer for manufacturing said hybrid fabric.

48. The method according to claim 47, wherein said parameter values are further determined according to desirable result of hybrid fabric with said synthetic layer fully or partially embedded within said textile base layer and respective composite, fully covered or fully exposed surface of said textile base layer.

49. The method of claim 32, further comprising laminating with thermoplastic cover before or after manufacturing said hybrid fabric.

50. The method according to claim 37, wherein said textile base layer is pre-treated by increasing its vacant space between its fibers to allow said synthetic layer better embed within.

51. Means for manufacturing hybrid fabric, said means comprising any one of plate press, drum press and knitting and sewing means configured for embedding synthetic layer within textile base layer.
